(19) United States
(12) Patent Application Publication
(10) Pub. No.: US 2022/0309364 A1
(43) Pub. Date: Sep. 29, 2022

(54) HUMAN-LIKE NON-PLAYER CHARACTER BEHAVIOR WITH REINFORCEMENT LEARNING

(71) Applicants: Advanced Micro Devices, Inc., Santa Clara, CA (US); ATI Technologies ULC, Markham (CA)

(72) Inventors: Thomas Daniel Perry, Bellevue, WA (US); Mehdi Saeedi, Markham (CA); Gabor Sines, Markham (CA)

(21) Appl. No.: 17/215,437

(22) Filed: Mar. 29, 2021

(51) Int. Cl. G06N 5/04; G06N 20/00; A63F 13/56

(52) U.S. Cl. CPC G06N 5/04; G06N 20/00; A63F 13/56; A63F 2300/6607

(57) ABSTRACT

Systems, apparatuses, and methods for creating human-like non-player character (NPC) behavior with reinforcement learning (RL) are disclosed. An artificial intelligence (AI) engine creates a NPC that has seamless movement when accompanying a player controlled by a user playing a video game. The AI engine is RL-trained to stay close to the player but not get in the player's way while acting in a human-like manner. Also, the AI engine is RL-trained to evaluate the quality of information that is received over time from other AI engines and then to act on the evaluated information quality. Each AI agent is trained to evaluate the other AI agents and determine whether another AI agent is a friend or a foe. In some cases, groups of AI agents collaborate together to either help or hinder the player. The capabilities of each AI agent are independent from the capabilities of other AI agents.

### BACKGROUND

### Description of the Related Art

Video games regularly face the challenge of generating realistic non-player characters (NPCs). For example, video games can include NPCs accompanying the player controller by the user, enemy NPCs, and other types of NPCs. For a follower NPC, typical implementations usually result in either the NPC leading the way or the NPC disappearing and being assumed to be with the player or pathfinding to follow the player. This leads to breaking immersion or frustration if the follower NPC behaves as a hindrance instead of a helper.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 is a block diagram of one implementation of a portion of a neural network.

FIG. 3 is a block diagram of another implementation of a neural network.

FIG. 4 is a block diagram of one implementation of a NPC generation neural network training system.

FIG. 5 is a block diagram of one implementation of a human-like NPC behavior generation neural network training system.

FIG. 6 is a diagram of one implementation of a user interface (UI) with follower NPCs.

FIG. 7 is a diagram of one example of a UI with multiple NPCs.

FIG. 8 is a generalized flow diagram illustrating one implementation of a method for generating human-like non-player character behavior with reinforcement learning.

FIG. 9 is a generalized flow diagram illustrating one implementation of a method for assigning scores to messages based on a truthfulness of the messages.

FIG. 10 is a generalized flow diagram illustrating one implementation of a method for training a machine learning engine to control a NPC's mood.

FIG. 11 is a generalized flow diagram illustrating one implementation of a method for ascertaining whether a NPC is a friend or foe by a machine learning engine.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Various systems, apparatuses, and methods for creating human-like non-player character behavior with reinforcement learning and supervised learning are disclosed herein. In one implementation, an artificial intelligence (AI) engine creates a non-player character (NPC) that has seamless movement when accompanying a player controlled by a user playing a video game application or accompanying other NPCs or entities in the game. Reinforcement learning (RL) is used to train the AI engine to stay close to the player and not get in the player's way while acting in a human-like manner. Also, the AI engine is trained to evaluate the quality of information that is received over time from other AI engines controlling other NPCs and then to act on the information based on the truthfulness associated with the information. Each AI agent is trained to evaluate the other AI agents and determine whether another AI agent is a friend or an enemy. In some cases, groups of AI agents collaborate together to either help or hinder the player. The capabilities of each AI agent are independent and can be different from the capabilities of other AI agents.

In one implementation, new states are crafted as part of a state machine or behavior tree to guide the actions of AI agents in a multi-agent game. In one implementation, each new state is crafted and trained individually using RL with the AI agent performing a specific task in the new state. The AI engine is trained using RL to control the state transitions between the customized states. During gameplay, new states are created and/or existing states are eliminated from the state machine as new information becomes available. In other implementations, states are created and/or trained using other techniques, and the transitions between states are controlled by other mechanisms.

In one implementation, a game begins with multiple agents having varying complexity levels of intelligence. Over time, one or more of the AI agents becomes a mastermind based on RL-training using the actions taken during the game by the player and the other AI agents. Depending on the implementation, the training is responding to the actions of other AI agents or the training is attempting to mimic the actions of a player or other AI agents. In one implementation, the mastermind AI agent hires other agents to assist in the task the mastermind AI agent is carrying out. This allows a more complex mastermind AI agent to control several simpler AI agents in order to compete with the player. In one implementation, RL-training includes manual supervision over time or at the beginning of the training.

In one implementation, during a multi-agent game, AI agents exhibit different personalities and moods. The different personalities are created during RL-training of the AI agents. Each AI agent is assigned a different personality, and the AI agents transition between different moods during gameplay. The personality assigned to an AI agent can be pre-defined by the programmer or selected randomly. Also, one or more of the AI agents are able to act on a whim by violating their personality directives. In one implementation, AI agents are rewarded when acting according to their personality and mood and penalized when not acting according to their personality and mood. The scores awarded to the AI agents will be used to adjust the various parameters of their corresponding neural networks. For example, if one agent is assigned to be a lazy agent, this agent should be slow in responding to a player's needs but at the same time should not stop doing its tasks. The reward system for the lazy agent is designed to reward slow yet consistent progress toward completing its tasks. In this case, a lazy agent reaching a goal too quickly would result in the reward system docking points from the agent. Other agents with other personalities can have other tailored reward systems.

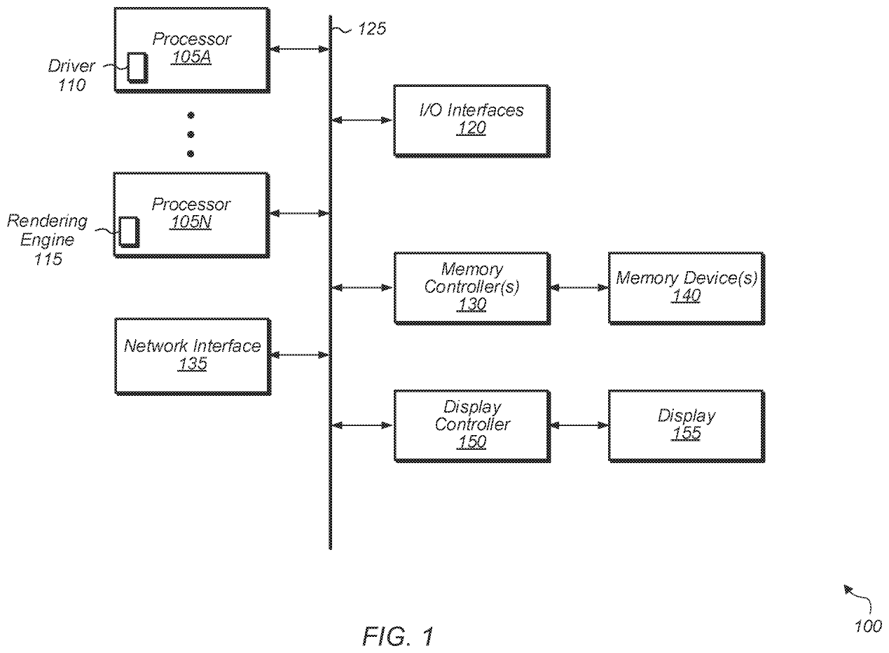

Referring now to FIG. 1, a block diagram of one implementation of a computing system 100 is shown. In one implementation, computing system 100 includes at least processors 105A-N, input/output (I/O) interfaces 120, bus 125, memory controller(s) 130, network interface 135, memory device(s) 140, display controller 150, and display 155. In other implementations, computing system 100 includes other components and/or computing system 100 is arranged differently. Processors 105A-N are representative of any number of processors which are included in system 100.

In one implementation, processor 105A is a general-purpose processor, such as a central processing unit (CPU). In this implementation, processor 105A executes a driver 110 (e.g., graphics driver) for communicating with and/or controlling the operation of one or more of the other processors in system 100. It is noted that depending on the implementation, driver 110 can be implemented using any suitable combination of hardware, software, and/or firmware. In one implementation, processor 105N is a data parallel processor with a highly parallel architecture, such as a dedicated neural network accelerator or a graphics processing unit (GPU) which provides pixels to display controller 150 to be driven to display 155.

A GPU is a complex integrated circuit that performs graphics-processing tasks. For example, a GPU executes graphics-processing tasks required by an end-user application, such as a video-game application. GPUs are also increasingly being used to perform other tasks which are unrelated to graphics. The GPU can be a discrete device or can be included in the same device as another processor, such as a CPU. Other data parallel processors that can be included in system 100 include digital signal processors (DSPs), field programmable gate arrays (FPGAs), application specific integrated circuits (ASICs), and so forth. In some implementations, processors 105A-N include multiple data parallel processors.

An emerging technology field is machine learning, with a neural network being one type of a machine learning model. Neural networks have demonstrated excellent performance at tasks such as hand-written digit classification and face detection. Other applications for neural networks include speech recognition, language modeling, sentiment analysis, text prediction, and others. In one implementation, processor 105N is a data parallel processor programmed to execute one or more neural network application to implement movement schemes for one or more non-player characters (NPCs) as part of a video-game application.

In one implementation, imitation learning is used to generate a movement scheme for a NPC. In this implementation, the movements of a player controlled by a user playing a video game application are used by a trained neural network which generates a movement scheme of movement controls to apply to a NPC. In another implementation, reinforcement learning is used to generate the movement scheme for the NPC. Any number of different trained neural networks can control any number of NPCs. The output(s) of the trained neural network(s) of NPC(s) are rendered into a user interface (UI) of the video game application in real-time by rendering engine 115. In one implementation, the trained neural network executes on one or more of processors 105A-N.

Memory controller(s) 130 are representative of any number and type of memory controllers accessible by processors 105A-N. While memory controller(s) 130 are shown as being separate from processors 105A-N, it should be understood that this merely represents one possible implementation. In other implementations, a memory controller 130 can be embedded within one or more of processors 105A-N and/or a memory controller 130 can be located on the same semiconductor die as one or more of processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, and so forth. Network interface 135 is able to receive and send network messages across a network. Bus 125 is representative of any number and type of interfaces, communication fabric, and/or other connectivity for connecting together the different components of system 100.

In various implementations, computing system 100 is a computer, laptop, mobile device, game console, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

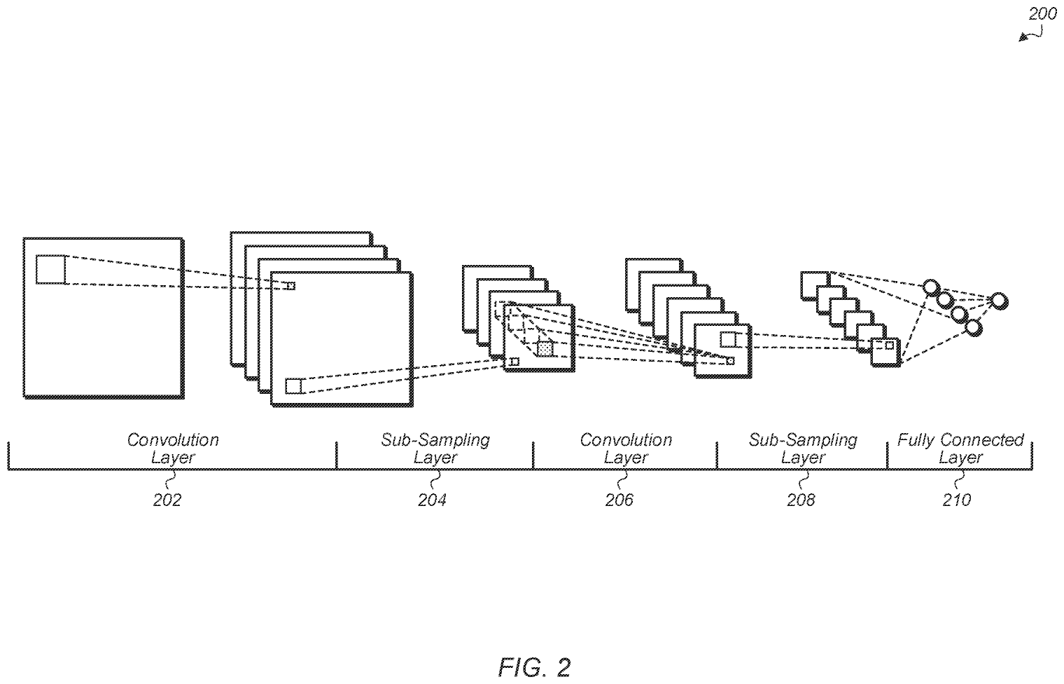

Turning now to FIG. 2, a block diagram of one implementation of a portion of a neural network 200 is shown. It is noted that the example of the portion of neural network 200 is merely intended as an example of a neural network that can be trained and used by various video game applications. The example of neural network 200 does not preclude the use of other types of neural networks. The training of a neural network can be performed using reinforcement learning (RL), supervised learning, or imitation learning in various implementations. It is noted that a trained neural network can use convolution, fully connected, long short-term memory (LSTM), gated recurrent unit (GRU), and/or other types of layers.

The portion of neural network 200 shown in FIG. 2 includes convolution layer 202, sub-sampling layer 204, convolution layer 206, sub-sampling layer 208, and fully connected layer 210. Neural network 200 can include multiple groupings of layers similar to those shown sandwiched together to create the entire structure of the network. The other groupings of layers that are part of neural network 200 can include other numbers and arrangements of layers than what is shown in FIG. 2. It is noted that layers 202-210 are merely intended as an example of a grouping of layers that can be implemented in back-to-back fashion in one particular embodiment. The arrangement of layers 202-210 shown in FIG. 2 does not preclude other ways of stacking layers together from being used to create other types of neural networks.

When implementing neural network 200 on a computing system (e.g., system 100 of FIG. 1), neural network 200 generates behavior and action controls for any number of NPCs associated with a player controlled by a user playing a video game application. The NPCs are then integrated into the video game application. The NPCs can implement a variety of schemes of different complexities depending on the particular video game application. For example, in one implementation, each NPC is assigned a personality, and the actions of the NPC are generated to match the assigned personality. Also, in another implementation, each NPC is assigned a mood, and each neural network 200 generates actions which correspond to the mood of the respective NPC. Other examples of different schemes that can be employed will be described throughout the remainder of this disclosure.

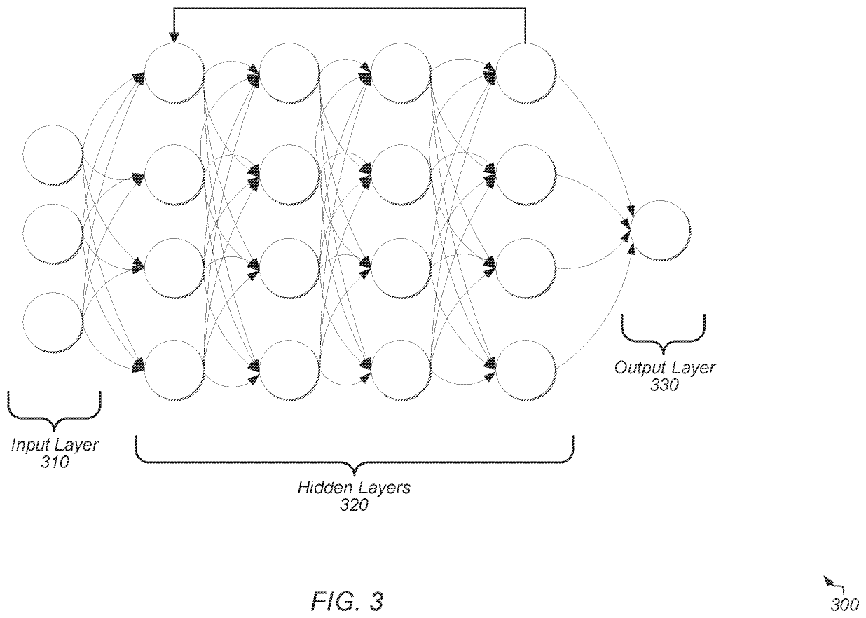

Referring now to FIG. 3, a block diagram of another implementation of a neural network 300 is shown. Neural network 300 illustrates another example of a neural network that can be implemented on a computing system (e.g., system 100 of FIG. 1). In one implementation, neural network 300 is a recurrent neural network (RNN) and includes at least input layer 310, hidden layers 320, and output layer 330. Hidden layers 320 are representative of any number of hidden layers, with each layer having any number of neurons. Neurons that are used for RNNs include long short-term memory (LSTM), gated recurrent unit (GRU), and others. Also, any number and type of connections between the neurons of the hidden layers may exist. Additionally, the number of backward connections between hidden layers 320 can vary from network to network. In other implementations, neural network 300 includes other arrangements of layers and/or other connections between layers that are different from what is shown in FIG. 3. In some cases, neural network 300 can include any of the layers of neural network 200 (of FIG. 2). In other words, portions or the entirety of convolutional neural networks (CNNs) can be combined with portions or the entirety of RNNs to create a single neural network. Also, any intermixing of neural network types together can be employed, such as intermixing fully connected and other neural network nodes. Examples of other network topologies that can be used or combined together with other networks include generative-adversarial networks (GANs), attention models, transformer networks, RNN-Transduce networks and their derivatives, and others.

In one implementation, as part of an environment where supervised learning is used to direct reinforcement learning, neural network 300 processes an input dataset to generate result data. In one implementation, the input dataset includes a plurality of real-time game scenario parameters and user-specific parameters of a user playing a video game. In this implementation, the result data indicates how to control the behavior and/or movements of one or more NPCs that will be rendered into the user interface (UI) along with the player controlled by the user while playing the video game. For example, imitation learning can be used in one implementation. In another implementation, the player data is being played back in a reinforcement learning environment so that neural network 300 can adapt and learn based on a replay of player input. In other implementations, the input dataset and/or the result data includes any of various other types of data.

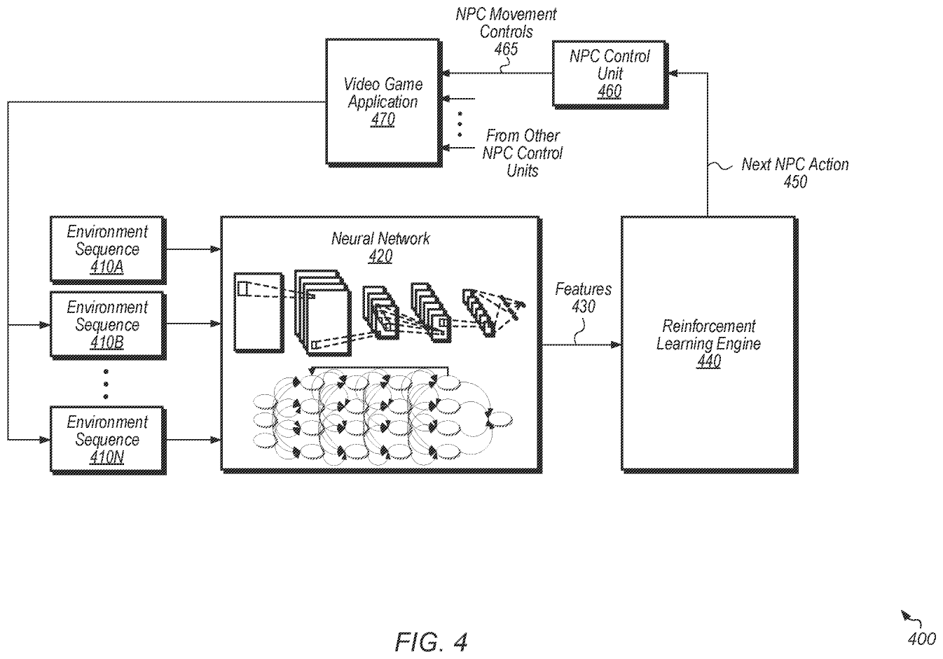

Turning now to FIG. 4, a block diagram of one implementation of a NPC generation neural network training system 400 is shown. System 400 represents one example of a pre-deployment training system for use in creating a trained neural network from a pre-deployment neural network 420. In other implementations, other ways of creating a trained neural network can be employed.

In one implementation, an environment sequence 410A is provided as an input to neural network 420, with environment sequence 410A representing an environment description and a time sequence of changes to the environment and entities in the environment. In general, environment sequence 410A is intended to represent a real-life example of a user playing a video game or a simulation of a user playing a video game. In one implementation, neural network 420 generates features 430 based on the game scenarios encountered or observed in environment sequence 410A. Features 430 are provided to reinforcement learning engine 440 which will be used as state to select the next NPC action 450 from a set of finite set of actions for the NPC. In various implementations, reinforcement learning engine 440 can include any combination of human involvement and/or machine interpretive techniques such as a trained discriminator or actor-critic as used in a GAN to generate feedback 450. There will be a new state after the selected NPC action 450. NPC control unit 460 generates control actions for the corresponding NPC and provides these control actions to video game application 470. Any number of other NPC control units corresponding to other NPCs in the game can also provide control actions for their respective NPCs. Video game application 470 generates the next environment sequence 410B from these inputs, neural network 420 will generate a new set of features 430 from the next environment sequence 410B, and this process can continue for subsequent gameplay.

In one implementation, if neural network 420, RL engine 440, and NPC control unit 460 have generated human-like NPC movement controls 465 that meet the criteria set out in a given movement scheme, then positive feedback will be generated to train neural network 420, RL engine 440, and NPC control unit 460. This positive feedback will reinforce the existing parameters (i.e., weights) for the layers of neural network 420, RL engine 440, and NPC control unit 460. On the other hand, if neural network 420, RL engine 440, and NPC control unit 460 have generated erratic NPC movement controls 465 that do not meet the criteria specified by the given movement scheme, then negative feedback will be generated, which will cause neural network 420, RL engine 440, and NPC control unit 460 to train their layers by adjusting the parameters to counteract the “error” that was produced. Subsequent environment sequences 410B-N are processed in a similar manner to continue the training of neural network 420 by refining the parameters of the various layers. Training may be conducted over a series of epochs in which for each epoch the totality or a subset of the training data set is repeated, often in random order of presentation, and the process of repeated training epochs is continued until the accuracy of the network reaches a satisfactory level. As used herein, an “epoch” is defined as one pass through the complete set of training data. Also, a “subset” refers to the common practice of setting aside a portion of the training data to use for validation and testing vectors.

In one implementation, system 400 attempts to have non-player characters (NPCs) stay close to a player and not get in the player's way. In a typical game in the prior art, follower NPCs have many limitations. For example, there is a walking speed problem where NPCs do not walk at the same speed as the player, causing the player to be frustrated and having to adjust their walking speed. Also, NPCs have a pathfinding problem where they get stuck in the terrain, such as trees, holes, doors, and so on. Still further, a common problem for NPCs is blocking the door after entering a building. For example, an NPC will wait in front of the door and the collision mesh will prevent the player from leaving the room or building. To combat these shortcomings of today's NPCs, player feedback is enabled during development to punish bad behavior with an in-game reporting tool. An AI agent training environment is employed with feedback to train an AI agent to perform better when functioning as an NPC follower.

In one implementation, a separate artificial intelligence (AI) engine controls each NPC independently of other NPCs. In another implementation, NPC control is performed by an NPC AI director where the director directs or influences the NPC indirectly. In either case, the AI engine or AI director controlling an NPC follows a player through varied terrain, doors, up stairs, jumping over railings/fences, jumping off of heights, and navigating other obstacles. The AI engine is trained to give the actual player, controlled by the user playing the video game, a first configurable amount of personal space and not stray beyond a second configurable amount of distance from the player when not prevented by the actual game environment. For example, if the actual player is in a small room, the NPC will by necessity invade the actual player's personal space if the NPC is in the small room with the actual player. Other exceptions are possible to the above rule. The first and second configurable amounts of distance are programmable and can differ from game to game and from NPC to NPC. In some game environments, the player will have multiple NPCs, and these NPCs can be independently controlled by different AI engines.

An NPC is rewarded for normal, human-like behavior and punished for erratic, annoying behavior. For example, in one implementation, the NPC should face forward when in motion and face the player when idle. Also, the NPC should not produce erratic behavior such as spinning in circles, moving in a non-standard way, and so on. During training, any erratic behavior, not facing forward while in motion, not facing the player when idle, or other negative behavior will result in the NPC being docked points. The training sessions are used to reinforce desired behavior and to eliminate erratic or other undesired behavior by the NPC.

In one implementation, the game play is defined by several puzzle rooms where the user has to accomplish a task defined by the rules of the environment. In the game, there is an AI construct/engine that is trying to kill the player within the environment. In the game, the rooms are defined by predetermined logic.

In one implementation, a room and facility is created where there is a fully controlled AI environment with traps. The goal of the AI engine is to prevent the player from reaching the player's goal via usage of traps. In one implementation, multiple independent AI constructs/engines also live in the environment and function cooperatively to stop the player. When the player succeeds, the AI engines learn to do better by adjusting parameters or running a full reinforcement learning (RL) training loop to refine the AI engines.

In one implementation, the RL training loop is executed in a cloud environment. During the RL training loop, parameters such as delays, angles, and other settings are adjusted while the cloud is refining the neural network so as to improve the AI's chances on future attempts. When the training of the neural network is complete, the newly trained neural network is downloaded and swapped in at run-time.

In various implementations, a video game application implements multi-agent control with a single RL-trained network, with each agent an independent AI engine. The agents are trained through live game play. There are live updates to the neural networks running the AI engines from a learning server during game play. The RL network allows for a single machine-learning based AI master controller to control different agents, with the different agents having varying capabilities.

In one implementation, a video game application supports the use of rumors during gameplay to enhance the user experience. The concept of a rumor is a piece of information with a fair bit of uncertainty attached to it. In some games, there are multi-agent systems with AI engines that communicate with each other. For multi-agent systems, there is an inherent distrust of the information. When a piece of information is received, there are inherently multiple states to the information:

1. The information is true and constant.

2. The information is deceitful (misinformation).

3. The information was true but the truthfulness has a limited time window.

4. The information is deceitful but becomes true (perhaps due to a mistake).

5. The information was not communicated properly and the quality of the information has degraded.

6. Parts of the information are omitted intentionally or mistakenly.

In addition to the multiple states of information, rumors have reliability associated to the source of the information. The reliability will increase over time as a source is proved trustworthy. Rumors could be inconsequential or incredibly important. Ascertaining the importance of information helps to increase the performance of the agent. Accordingly, some portion of the AI engine will be dedicated to determining the importance and trustworthiness of information received from other AI engines.

Each AI agent predicts which of the above categories a piece of information falls into when receiving the information from another AI agent. In other implementations, other categories can be used in addition to the six listed above. These six categories are meant to serve as examples of one implementation and do not preclude the use of other categories for classifying received information.

The behavior of an AI agent follows from the categorizing of the information received from another AI agent. At a later point in time, the AI agent can reassess the previously received information to determine if the information should be recategorized into a new category based on subsequently obtained information.

In one implementation, a user plays a multi-agent ecosystem game. Individual AI agents make up the ecosystem in this implementation. Each AI agent has unique goals, sensor, and actions available to the AI agent. Also, the AI agents have varying complexities of neural networks that are controlling the actions of the AI agents. Training of the AI agents is performed in a variety of different manners, with multiple different types of training potentially combined together to create a trained AI agent. For example, training is experimented with each AI agent in seclusion in one implementation. Then, training is continued within the multi-agent environment. The players controlled by the user and the environment provide external stimulus to influence the AI agents. In one implementation, the players control individual AI agents to force the AI agents to perform some action or task when the AI agents are not operating in automatic mode.

In one implementation, the concept of ascertaining whether an AI agent is a friend or an enemy in a multi-agent game is supported. This concept is an extension of a multi-agent ecosystem game but with an emphasis on hostile agent identification. In this type of game, there are many different individual AI agents where some of the AI agents have shared interests. However, the AI agents at the beginning of the game do not know about the role of the other agents.

In one implementation, the AI engines are programmed for cooperative group behavior in multi-agent games. This concept is an extension of a multi-agent ecosystem game but with an emphasis on independent group cooperation and communication. In one implementation, there are multiple AI agents that are enemies that collaborate to eliminate the player. The AI agents adapt to the player and work together by pooling their resources and taking advantage of opportunities created by each other. A training environment for the AI agents can include training in seclusion or training to collaborate. There can be inter-network stimulus to create a communication path between AI agents. In one implementation, a producer/consumer concept is employed in combination with a multi-agent ecosystem. Each AI agent can be a producer of some products and a consumer of other products.

In one implementation, a state machine or a behavior tree is used for controlling the actions of one or more AI agents. States of the state machine are created based on individual training using reinforcement learning such that each state involves the AI agent performing a specific task. In one implementation, reinforcement learning is used to control the state transitions between the states of the state machine.

In one implementation, an AI agent is programmed as a mastermind within the environment of a multi-agent game. This concept is an extension of a multi-agent ecosystem game but with an emphasis on independent group cooperation and a hierarchy that AI agents are programmed to obey. The environment is programmed with different complexity levels of enemy AI intelligence. In one implementation, multiple AI agents cooperate and/or attack the player during the game. In the event that the player is the mastermind, the player issues orders to the AI engines and the AI engines obey the order so as to carry out a task. It is noted that an “AI engine” can also be referred to as an “AI agent”.

In some implementations a more complex AI engine mastermind is employed. For example, in one implementation, a more complex AI engine controls several simpler AI engines to support the player or compete against the player. In this implementation, a command structure is utilized as well as different levels of AI engine complexity. The different levels of complexity give rise to understanding the different performance characteristics of the different complexities.

In one implementation, a mastermind does not exist at the beginning of the game. Rather, one of the AI engines learns from its own actions and also learns from the experiences of other AI engines to become a more capable AI engine. As the AI engine becomes more capable through reinforcement learning, the AI engine hires other AI engines gradually as the AI engine gets more powerful. Also, in one implementation, one AI engine is programmed to manipulate other AI engines. The other agents are affected in varying degrees based on their individual characteristics. Generally speaking, these implementations use AI agents that think independently and are able to receive orders. Also, in some cases, an AI agent ignores orders from a central controller based on reinforcement learning.

In one implementation, RL is used to create accurate behavior as well as interesting and dynamic behavior that will enhance the user experience of playing the game. In this implementation, the concept of personality is built into the neural network of an AI agent. Using RL, the AI agent is adjusted with weighted factors in the reward function to reward characteristics related to personality.

In one implementation, a mathematical emulation of personality is employed using reward modeling and/or environmental modeling. A mathematic emulation can be implemented using a trained neural network in one example. In some implementations, future modifications to the AI agents are performed using learned personality that is a combination of initial traits and environmental causes. This results in AI agents having dynamically learned personalities that are not fixed by a programmer.

For example, some of the types of personalities that the AI agents can be trained to emulate include a kind personality, a cruel personality, a lazy personality, a diligent personality, and so on. For an AI agent trained to have a kind personality, the training involves the AI agent being rewarded for performing kind actions in a game such as healing a player, giving or sharing an item, providing information, and so on. An AI agent trained to have a cruel personality is rewarded for taking an item from a player, wounding a player before killing, and so on. An AI agent trained with a lazy personality is rewarded for being inactive whenever other circumstances do not prevent this, such as not being monitored by an agent or player that is hierarchically superior, not being in danger, etc. An AI agent trained to have a diligent personality is rewarded for working to exhaustion. Other types of personalities and/or other training methods to emulate these personalities are possible and are contemplated.

To expand on the training of AI agents with different personalities, the AI agents are also trained to have different moods in one implementation. The neural network of an AI agent is trained to emulate moods such as happy, angry, vengeful, and so on. In one implementation, these moods are triggered via real-time configuration of mood parameters by performing random exploration during training where exploration can be done randomly, according to an algorithm, mathematical function or an alternate neural network to explore action space outside its assigned role. The reward function can also be adjusted when an agent acts according to the agent's current mood setting. For example, if an AI agent currently has an angry mood setting, then AI agent is rewarded for using excessive force, randomly destroying objects, or other similar actions.

In another enhancement to the above behavior, an AI agent can be programmed to act according to a whim (i.e., go outside the assigned role). For example, in one implementation, an AI agent performs an action in opposition to its neural network. In a RL environment, this is performed with exploration. However, exploration typically relates to taking a random action at a random time. In contrast, when an AI agent acts on a whim, the AI agent takes a sequence of actions through an alternative exploration policy. In one implementation, multiple-policy RL is employed and exploration approaches that compensate for random exploration so that the actions are not erratic but rather more intelligent.

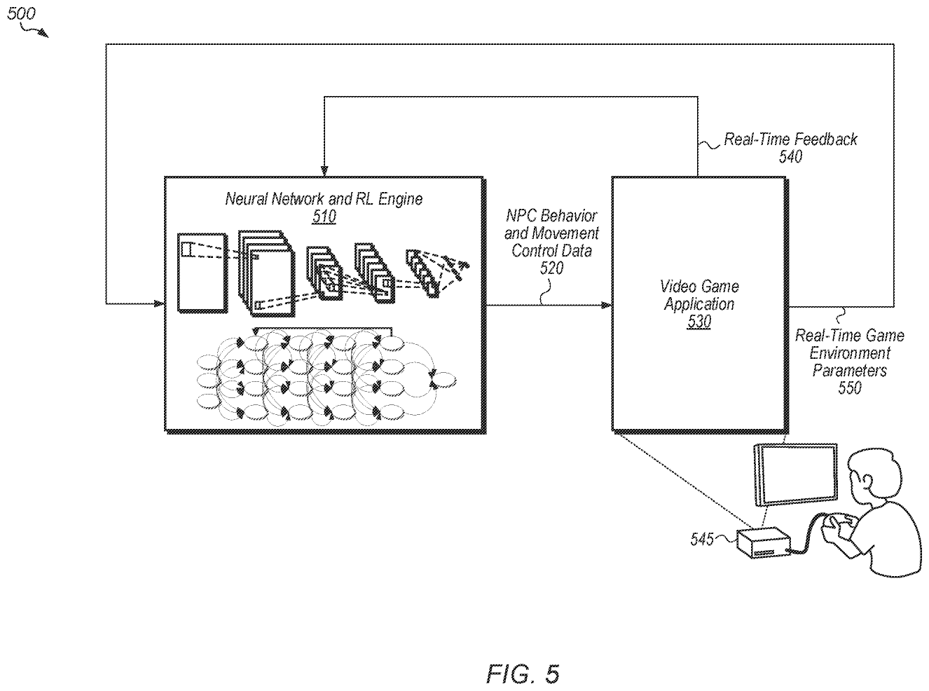

Referring now to FIG. 5, a block diagram of one implementation of a human-like NPC behavior generation neural network training system 500 is shown. System 500 represents a real-time use environment when a neural network and RL engine 510 has been deployed as part of a video game application 530 in the field to continue to adapt the weights of the layers of neural network and RL engine 510 to improve the human-like NPC behavior that is generated. These updated weights can be uploaded to the cloud to allow these updates to be applied to other neural networks. Accordingly, after neural network and RL engine 510 has been deployed, incremental training can continue so as to refine the characteristics of neural network and RL engine 510. This allows neural network and RL engine 510 to improve the generation of NPC behavior and movement control data 530 so as to enhance the overall user experience.

In one implementation, neural network and RL engine 510 receives real-time game environment parameters 550 as inputs. Real-time game environment parameters 550 are those parameters collected in real-time during use of the video game application 530 by a user. Neural network and RL engine 510 uses real-time environment parameters 550 as inputs to the layers of neural network and RL engine 510 so as to generate NPC behavior and movement control data 530. NPC behavior and movement control data 530 is then provided to video game application 530 to control the behavior and movement of a NPC which is rendered and displayed to the user. While the user is playing the video game, the real-time environment parameters 550 will be captured, such as the movement of the player controlled by the user, the movement and actions of other NPCs controlled by other neural networks, information received from other NPCs, and so on.

In one implementation, video game application 530 executes on a game console 545. Game console 545 includes any of the components shown in system 100 (of FIG. 1) as well as other components not shown in system 100. In another implementation, video game application 530 executes in the cloud as part of a cloud gaming scenario. In a further implementation, video game application 530 executes in a hybrid environment that uses a game console 545 as well as some functionality in the cloud. Any of the other components shown in FIG. 5 can be implemented locally on the game console 545 or other computer hardware local to the user and/or one or more of these components can be implemented in the cloud.

Real-time feedback 540 is used to incrementally train neural network and RL engine 510 after deployment in the field. In one implementation, real-time feedback 540 is processed to generate a feedback score that is provided to neural network and RL engine 510. The higher the feedback score, the higher the positive feedback that is provided to neural network and RL engine 510 to indicate that neural network and RL engine 510 generated appropriate NPC behavior and movement control data 520. Also, in this implementation, the lower the feedback score, the more negative feedback that is provided to neural network and RL engine 510 to indicate that neural network and RL engine 510 did a poor job in generating NPC behavior and movement control data 520. This feedback, either positive or negative, which can vary throughout the time the user is playing video game application 530, will enable neural network and RL engine 510 to continue its training and perform better in future iterations when dynamically generating NPC behavior and movement control data 520. In one implementation, the learning rate of neural network and RL engine 510 is held within a programmable range to avoid making overly aggressive changes to the trained parameters in the field. The learning rate is a variable scale factor which adjusts the amount of change that is applied to the trained parameters during these incremental training passes.

Neural network and RL engine 510 can have different settings for different scenes, for different video games, for different players/users, and these settings can be pre-loaded based on where in the game the user is navigating, which video game the user is playing, and so on. Neural network and RL engine 510 can have any number of different sets of parameters for an individual game and these can be loaded and programmed into the layers in real-time as different phases of the game are encountered. Each set of parameters is trained based on real-time feedback 540 received during the corresponding part of the game independently from how the other sets of parameters are trained in their respective parts of the game.

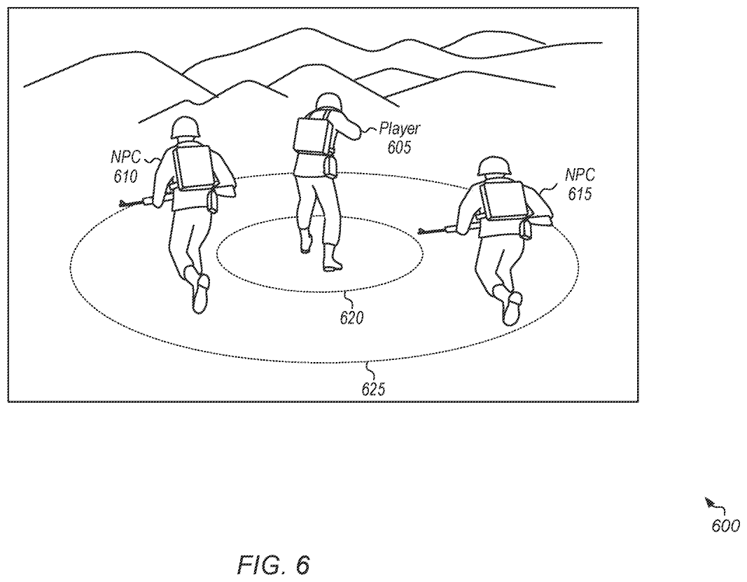

Turning now to FIG. 6, a diagram of one example of a user interface (UI) 600 with follower NPCs is shown. In one implementation, UI 600 is rendered for a video game application, with UI 600 including a player 605 controlled by the user playing the video game application. In this implementation, two NPCs 610 and 615 are rendered within the UI to follow the player and comply with movement schemes generated by corresponding machine learning engines (e.g., trained neural networks). In other words, a first machine learning engine controls the movements of NPC 610 to comply with a first movement scheme, and a second machine learning engine controls the movements of NPC 615 to comply with a second movement scheme.

In one implementation, the first and second movements schemes define a plurality of regions based on the distance to player 605. For example, region 620 is defined as the area in close proximity to player 605 which is not to be invaded by NPCs 610 and 615. It is noted that the boundary of region 620 is shown with a dotted line which is labeled with “620”. The first and second machine learning engines will control the movements of NPCs 610 and 615 to prevent them from entering region 620. Also, region 625 is defined which is a region bounded on the inside by the boundary of region 620 and bounded on the outside by the dotted line labeled with “625”. The first and second machine learning engines will control the movements of NPCs 610 and 615 to keep them within region 625. It is noted that in other implementations, other numbers of regions can be defined and the movements of NPCs can be controlled based on observing certain rules with respect to these regions.

During training, NPCs 610 and 615 are rewarded for staying within region 625 and punished for entering region 620 or exiting region 625 by straying too far away from player 605. A score is maintained for each NPC 610 and 615 and then their corresponding machine learning engines will be trained based on the result of their scores after some duration of training time has elapsed. Also, other types of behavior can be observed and used to train the first and second machine learning engines controlling NPCs 610 and 615, respectively. For example, human-like behavior by NPCs 610 and 615 is rewarded while erratic behavior by NPCs 610 and 615 is punished. In one implementation, the goal is to make NPCs 610 and 615 mimic behavior indicative of other players controlled by human users. In one implementation, NPCs 610 and 615 are trained using imitation learning via examples of NPCs following close to a player and reacting to movement changes for the player. The reward function encourages adherence to the NPC example movement and punishes behavior that is not consistent with the NPC example movement.

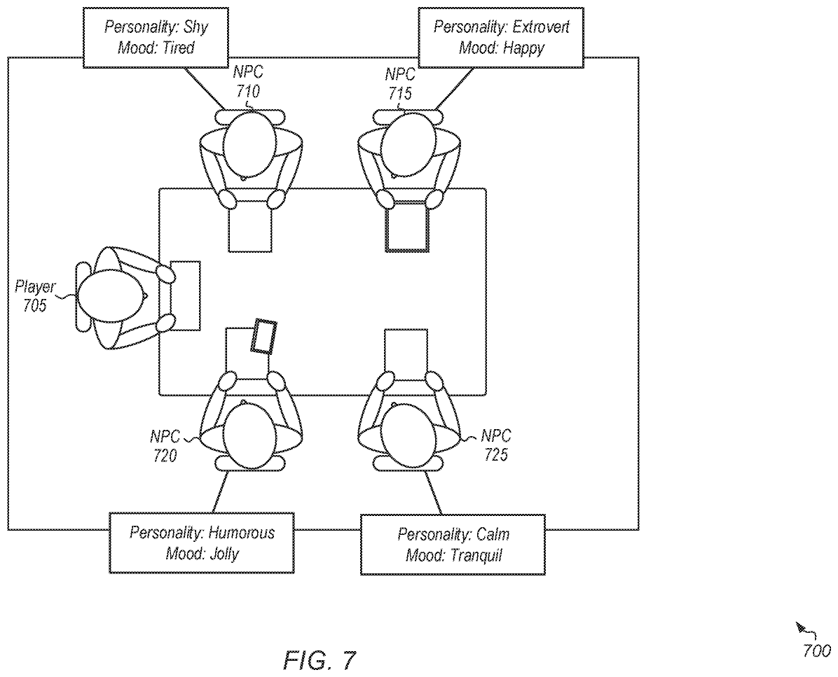

Referring now to FIG. 7, a diagram of one example of a user interface (UI) 700 with multiple NPCs is shown. UI 700 is representative of one example of a UI which is generated for a video game application. In one implementation, UI 700 includes player 705 which is controlled by a user playing a video game. UI 700 also includes NPCs 710, 715, 720, and 725, which are representative of any number of NPCs that are included in a particular scene of the video game. In one implementation, each NPC 710, 715, 720, and 725 is controlled by a separate machine learning engine (e.g., trained neural network) to behave in accordance with its assigned personality and mood. Also, in some implementations, a given machine learning engine randomly acts on whims that are not in accordance with the NPC's assigned personality and mood.

In one implementation, the personality and mood of each NPC are predetermined by the creators of the video game application. In another implementation, personality and mood of one or more NPC are determined in a random fashion. In a further implementation, the player of the video game determines how the personalities and moods are assigned to the NPCs. In other implementation, any combination of these techniques and/or other techniques can be used for assigned personalities and moods to the NPC.

As shown in FIG. 7, NPC 710 has a shy personality and tired mood. The actions (e.g., yawns) that are generated for NPC 710 and the conversation generated by NPC 710 will match the shy personality and tired mood. During training, actions and dialogue that match the shy personality and tired mood will be rewarded while other types of behavior inconsistent with this personality and mood will be penalized. Similarly, NPCs 715, 720, and 725 will be trained to reinforce behavior matching their personalities and moods. For example, in this scenario, NPC 715 has an extroverted personality and happy mood, NPC 720 has a humorous personality and jolly mood, and NPC 725 has a calm personality and tranquil mood. In other implementations, other types of personalities and other types of moods can be assigned to the various NPCs.

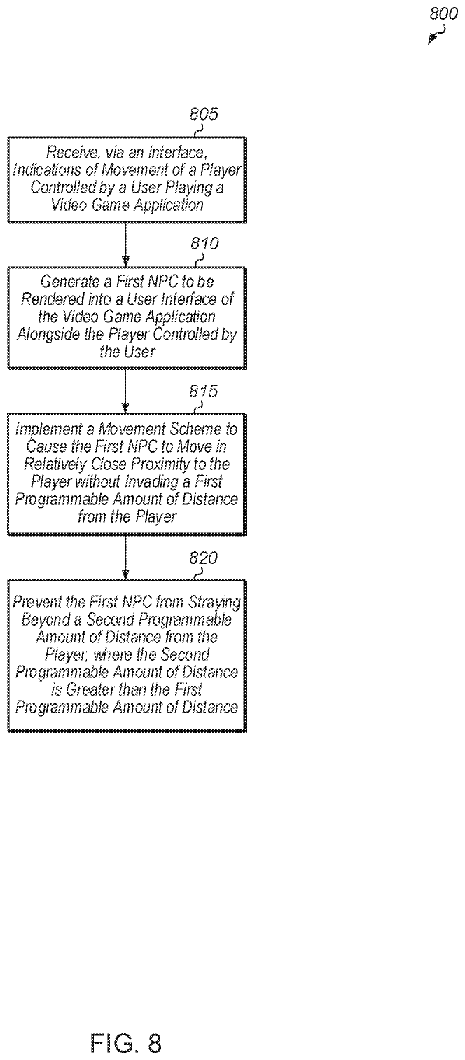

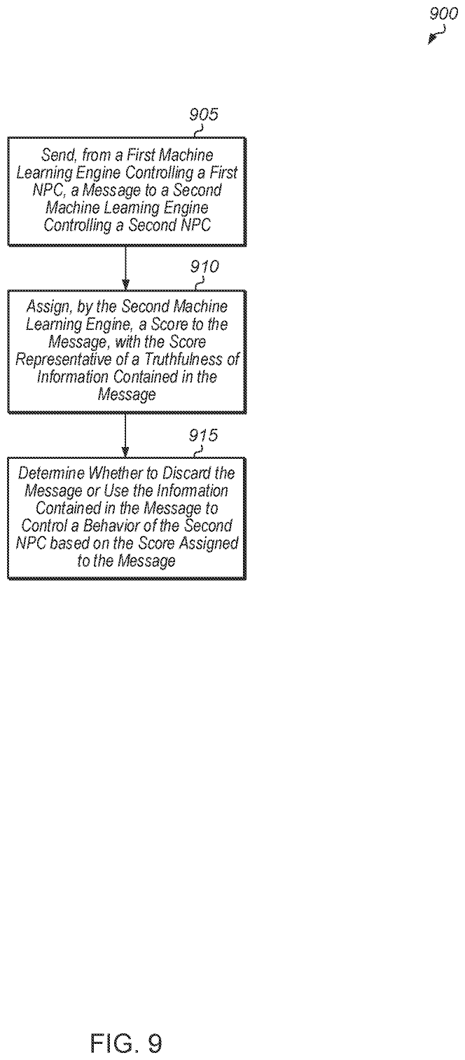

Turning now to FIG. 8, one implementation of a method 800 for generating human-like non-player character behavior with reinforcement learning is shown. For purposes of discussion, the steps in this implementation and those of FIG. 9-11 are shown in sequential order. However, it is noted that in various implementations of the described methods, one or more of the elements described are performed concurrently, in a different order than shown, or are omitted entirely. Other additional elements are also performed as desired. Any of the various systems or apparatuses described herein are configured to implement method 800.

A machine learning engine receives, via an interface, indications of movement of a player controlled by a user playing a video game application (block 805). Also, the video game application generates a first non-player character (NPC) to be rendered into a user interface (UI) alongside the player controlled by the user (block 810). Next, the machine learning engine implements a movement scheme to cause the first NPC to move in relatively close proximity to the player without invading a first programmable amount of distance from the player (block 815). Also, the machine learning engine prevents the first NPC from straying beyond a second programmable amount of distance from the player, where the second programmable amount of distance is greater than the first programmable amount of distance (block 820). After block 820, method 800 ends.

Turning now to FIG. 9, one implementation of a method 900 for assigning scores to messages based on a truthfulness of the messages is shown. A first machine learning engine controlling a first NPC sends a message to a second machine learning engine controlling a second NPC (block 905). In response to receiving the message, the second NPC assigns a score to the message, with the score representative of a truthfulness of information contained in the message (block 910). In one implementation, the score also has additional metadata such as the time the message was received and information about the entity that provided the message. Next, the second machine learning engine determines whether to discard the message or use the information contained in the message to control a behavior of the second NPC based on the score assigned to the message (block 915). After block 915, method 900 ends.

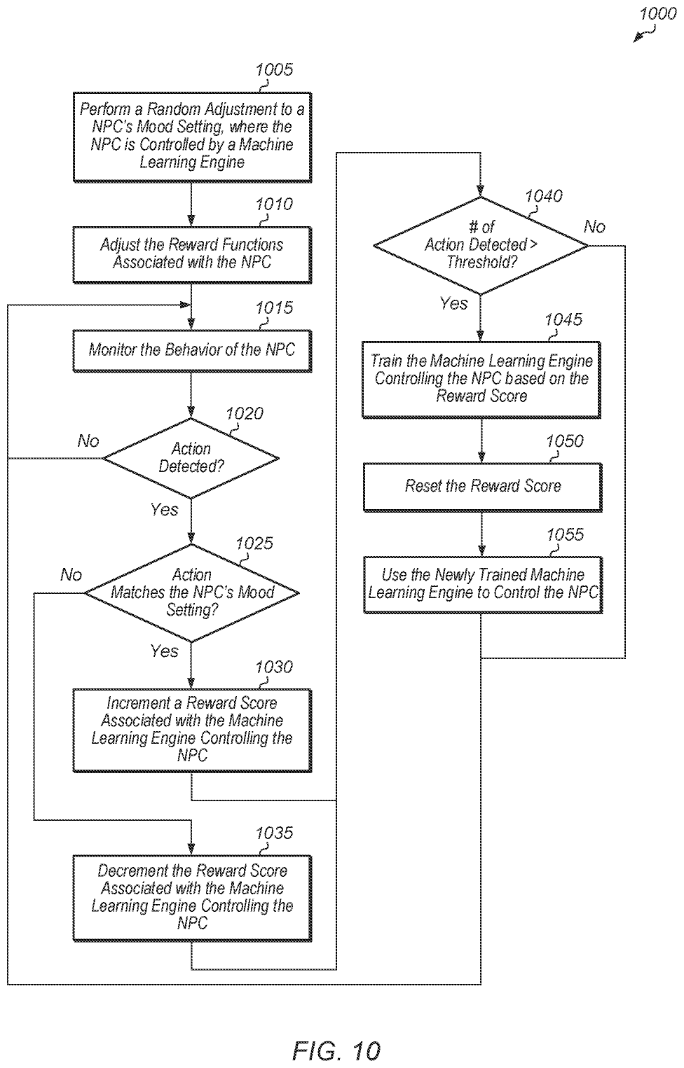

Turning now to FIG. 10, one implementation of a method 1000 for training a machine learning engine to control a NPC's mood is shown. A reinforcement learning engine performs a random adjustment to a NPC's mood setting, where the NPC is controlled by a machine learning engine (block 1005). Also, the reinforcement learning engine adjusts the reward functions associated with the NPC (block 1010). Next, the reinforcement learning engine monitors the behavior of the NPC (block 1015). If an action is detected (conditional block 1020, “yes” leg), then the reinforcement learning engine determines if the action matches the NPC's mood setting (conditional block 1025).

If the action matches the NPC's mood setting (conditional block 1025, “yes” leg), then the reinforcement learning engine increments a reward score associated with the machine learning engine controlling the NPC (block 1030). Otherwise, if the action does not match the NPC's mood setting (conditional block 1025, “no” leg), then the reinforcement learning engine decrements the reward score associated with the machine learning engine controlling the NPC (block 1035). After blocks 1030 and 1035, if more than a threshold number of actions have been detected (conditional block 1040, “yes” leg), then the machine learning engine controlling the NPC is trained based on the reward score (block 1045). Alternatively, a threshold amount of time, the reward score leaving a given range, or other condition can cause the reward score to be used for training the machine learning engine which controls the NPC.

In one implementation, the reward score is used to generate an error value which is fed back into the machine learning engine in a backward propagation pass to train the machine learning engine. For example, the higher the reward score, the more the existing parameters are reinforced, and the lower the reward score, the more the existing parameters are changed to cause different behavior by the NPC. After block 1045, the reward score is reset (block 1050), the newly trained machine learning engine is used to control the NPC (block 1055), and then method 1000 returns to block 1005.

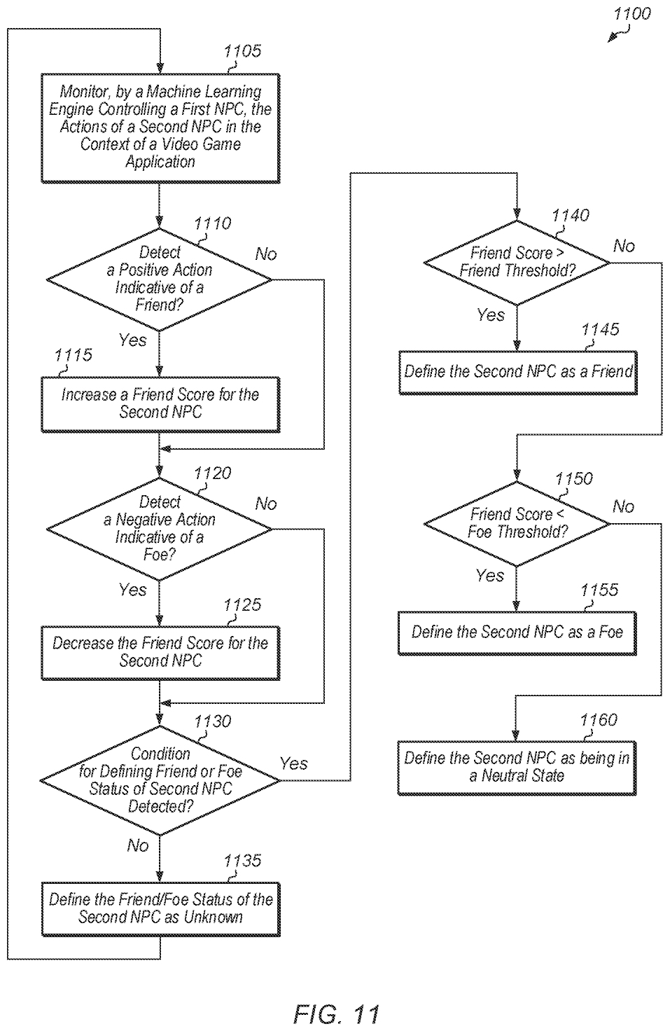

Referring now to FIG. 11, one implementation of a method 1100 for ascertaining whether a NPC is a friend or foe by a machine learning engine is shown. A machine learning engine controlling a first NPC monitors the actions of a second NPC in the context of a video game application (block 1105). In one implementation, the machine learning engine is trying to ascertain whether the second NPC is a friend or foe for a particular video game application. If the machine learning engine detects a positive action of the second NPC which is indicative of a friend (conditional block 1110, “yes” leg), then the machine learning engine increases a friend score for the second NPC (block 1115). If the machine learning engine detects a negative action of the NPC which is indicative of a foe (conditional block 1120, “yes” leg), then the machine learning engine decreases the friend score for the second NPC (block 1125).

If a condition for making a decision about the friend or foe status of the second NPC is detected (conditional block 1130, “yes” leg), then the machine learning engine compares the friend score to a friend threshold (conditional block 1140). For example, if the number of interactions with the second NPC has reached an interaction threshold, then the condition for making a decision about the friend/foe status of the second NPC is satisfied. Alternatively, if a decision needs to be made whether the first NPC should attack the second NPC within the game, then the machine learning engine needs to determine if the second NPC is a friend or foe. In other implementations, other conditions for making a decision about the friend/foe status of the second NPC can be employed. Otherwise, if a condition for making a decision about the friend or foe status of the second NPC is not detected (conditional block 1130, “no” leg), then the machine learning engine defines the friend/foe status of the second NPC as unknown (block 1135), and then method 1100 returns to block 1105.

If the friend score is greater than the friend threshold (conditional block 1140, “yes” leg), then the machine learning engine defines the second NPC as a friend (block 1145). The machine learning engine can then make one or more decisions based on the second NPC being a friend after block 1145. If the friend score is less than a foe threshold (conditional block 1150, “yes” leg), then the machine learning engine defines the second NPC as a foe (block 1155). The machine learning engine can then make one or more decisions based on the second NPC being a foe after block 1155. Otherwise, if the friend score is greater than or equal to the foe threshold (conditional block 1150, “no” leg), then the machine learning engine defines the second NPC as being in a neutral state (block 1160). Alternatively, in other implementations, the friend score can be compared to other numbers of thresholds than what is shown in method 1100. After blocks 1145, 1155, and 1160, method 1100 ends. It is noted that method 1100 can be repeated on a periodic basis. It is also noted that method 1100 can be extended to monitor multiple different NPCs rather than only monitoring a single NPC.

In various implementations, program instructions of a software application are used to implement the methods and/or mechanisms described herein. For example, program instructions executable by a general or special purpose processor are contemplated. In various implementations, such program instructions are represented by a high level programming language. In other implementations, the program instructions are compiled from a high level programming language to a binary, intermediate, or other form. Alternatively, program instructions are written that describe the behavior or design of hardware. Such program instructions are represented by a high-level programming language, such as C. Alternatively, a hardware design language (HDL) such as Verilog is used. In various implementations, the program instructions are stored on any of a variety of non-transitory computer readable storage mediums. The storage medium is accessible by a computing system during use to provide the program instructions to the computing system for program execution. Generally speaking, such a computing system includes at least one or more memories and one or more processors configured to execute program instructions.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. An apparatus comprising:
an interface; and
a first machine learning engine configured to:
receive, via the interface, indications of movement of a player controlled by a user playing a video game application;
implement a movement scheme for a first non-player character (NPC) to remain in relatively close proximity to the player without invading a first programmable amount of distance from the player; and
cause the first NPC to not exceed a second programmable amount of distance from the player, wherein the second programmable amount of distance is greater than the first programmable amount of distance;
wherein the apparatus is configured to render the first NPC into a user interface (UI) alongside the player following the movement scheme enforced by the first machine learning engine.

2. The apparatus as recited in claim 1, further comprising a second machine learning engine configured to:
receive a message from the first machine learning engine;
assign a score to the message, wherein the score is representative of a truthfulness of information contained in the message, and wherein the score includes metadata indicating a time when the message was received and information about the first NPC; and
determine whether to discard the message or use the message to control a behavior of a second NPC based on the score assigned to the message, wherein the second NPC is different from the first NPC.

3. The apparatus as recited in claim 2, wherein the second machine learning engine is further configured to implement a second movement scheme to control movements of the second NPC, and wherein the second machine learning engine has a different complexity level from the first machine learning engine.

4. The apparatus as recited in claim 3, wherein the second machine learning engine is further configured to:
maintain a friend score generated based on actions of the first NPC;
compare the friend score to a plurality of thresholds responsive to observing a given number of actions of the first NPC;
designate the first NPC as a friend of the second NPC responsive to the friend score being greater than a friend threshold; and
designate the first NPC as a foe of the second NPC responsive to the friend score being less than a foe threshold.

5. The apparatus as recited in claim 1, wherein the first machine learning engine is further configured to:
receive feedback on whether behavior of the first NPC is appropriate; and
train one or more parameters of a first neural network responsive to receiving the feedback on behavior of the first NPC.

6. The apparatus as recited in claim 1, further comprising a reinforcement learning engine, wherein the reinforcement learning engine is configured to:
receive, from the first machine learning engine, features based on the game scenarios encountered in an environment sequence; and
select a next action for the first NPC based on the features.

7. The apparatus as recited in claim 6, wherein the first machine learning engine is further configured to:
receive a personality score generated based on whether behavior of the first NPC matches an assigned personality and mood; and
train one or more parameters of a first neural network based on the personality score.

8. A method comprising:
receiving, by a machine learning engine, indications of movement of a player controlled by a user playing a video game application;
implementing a movement scheme for a first non-player character (NPC) to remain in relatively close proximity to the player without invading a first programmable amount of distance from the player;
causing the first NPC to not exceed a second programmable amount of distance from the player, wherein the second programmable amount of distance is greater than the first programmable amount of distance; and
rendering the first NPC into a user interface (UI) alongside the player following the movement scheme enforced by the first machine learning engine.

9. The method as recited in claim 8, further comprising:
receiving, by a second machine learning engine, a message from the first machine learning engine;
assigning a score to the message, wherein the score is representative of a truthfulness of information contained in the message, and wherein the score includes metadata indicating a time when the message was receiving and information about the first NPC; and
determining whether to discard the message or use the message to control a behavior of a second NPC based on the score assigned to the message, wherein the second NPC is different from the first NPC.

10. The method as recited in claim 9, further comprising implementing a second movement scheme to control movements of the second NPC, and wherein the second machine learning engine has a different complexity level from the first machine learning engine.

11. The method as recited in claim 10, further comprising the second machine learning engine:
maintaining a friend score generated based on actions of the first NPC;
comparing the friend score to a plurality of thresholds responsive to observing a given number of actions of the first NPC;
designating the first NPC as a friend of the second NPC responsive to the friend score being greater than a friend threshold; and
designating the first NPC as a foe of the second NPC responsive to the friend score being less than a foe threshold.

12. The method as recited in claim 8, further comprising:
receiving feedback on whether behavior of the first NPC is appropriate; and
training one or more parameters of a first neural network responsive to receiving the feedback on behavior of the first NPC.

13. The method as recited in claim 8, further comprising:
receiving, from the first machine learning engine by a reinforcement learning engine, features based on the game scenarios encountered in an environment sequence; and
selecting a next action for the first NPC based on the features.

14. The method as recited in claim 13, further comprising the first machine learning engine:
receiving a personality score generated based on whether behavior of the first NPC matches an assigned personality and mood; and
training one or more parameters of a first neural network based on the personality score.

15. A system comprising:
a first machine learning engine configured to:
receive indications of movement of a player controlled by a user playing a video game application;
implement a movement scheme for a first non-player character (NPC) to remain in relatively close proximity to the player without invading a first programmable amount of distance from the player;
cause the first NPC to not exceed a second programmable amount of distance from the player, wherein the second programmable amount of distance is greater than the first programmable amount of distance; and
a rendering engine configured to render the first NPC into a user interface (UI) alongside the player following the movement scheme enforced by the first machine learning engine.

16. The system as recited in claim 15, further comprising a second machine learning engine configured to:
receive a message from the first machine learning engine;
assign a score to the message, wherein the score is representative of a truthfulness of information contained in the message, and wherein the score includes metadata indicating a time when the message was receiving and information about the first NPC; and
determine whether to discard the message or use the message to control a behavior of a second NPC based on the score assigned to the message, wherein the second NPC is different from the first NPC.

17. The system as recited in claim 16, wherein the second machine learning engine is further configured to implement a second movement scheme to control movements of the second NPC, and wherein the second machine learning engine has a different complexity level from the first machine learning engine.

18. The system as recited in claim 17, wherein the second machine learning engine is further configured to:
maintain a friend score generated based on actions of the first NPC;
compare the friend score to a plurality of thresholds responsive to observing a given number of actions of the first NPC;
designate the first NPC as a friend of the second NPC responsive to the friend score being greater than a friend threshold; and
designate the first NPC as a foe of the second NPC responsive to the friend score being less than a foe threshold.

19. The system as recited in claim 15, wherein the first machine learning engine is further configured to:
receive feedback on whether behavior of the first NPC is appropriate; and
train one or more parameters of a first neural network responsive to receiving the feedback on behavior of the first NPC.

20. The system as recited in claim 15, further comprising a reinforcement learning engine configured to:
receive, from the first machine learning engine, features based on the game scenarios encountered in an environment sequence; and
select a next action for the first NPC based on the features.
